(19) United States
(12) Patent Application Publication
(10) Pub. No.: US 2016/0253166 A1
(43) Pub. Date: Sep. 1, 2016

(54) OILFIELD APPLICATION SYSTEM

(71) Applicant: SCHLUMBERGER TECHNOLOGY CORPORATION, Houston, TX (US)

(72) Inventors: Jeff David Rubenstein, Sugar Land, TX (US); Tze W. Ma, Spring, TX (US); Julian Moreno, Houston, TX (US); Yu Lin, Katy, TX (US); Eric Tabanou, Houston, TX (US)

(21) Appl. No.: 15/148,224

(22) Filed: May 6, 2016

Related U.S. Application Data
(62) Division of application No. 13/024,009, filed on Feb. 9, 2011.

(51) Int. Cl. G06F 9/445

(52) U.S. Cl. CPC G06F 8/65; G06F 8/61

(57) ABSTRACT

A computerized system for oil field applications. The computerized system may include an oilfield application and an oilfield application development kit that provides a software architecture for developing one or more plug-in components that may be executable by the oilfield application. The computerized system may also include an online distribution center that facilitates access to the plug-in components.

### BACKGROUND

1. Field of the Invention

Implementations of various technologies described herein generally relate to a computer system running an oilfield application.

2. Description of the Related Art

The following descriptions and examples are not admitted to be prior art by virtue of their inclusion within this section.

Operations, such as surveying, drilling, wireline testing, completions, production, planning and field analysis, are typically performed to locate and gather valuable downhole fluids. Surveys are often performed using acquisition methodologies, such as seismic scanners or surveyors to generate maps of underground formations. These formations are often analyzed to determine the presence of subterranean assets, such as valuable fluids or minerals, or to determine whether the formations include characteristics suitable for storing fluids.

During drilling and production operations, data is typically collected for analysis and/or monitoring of the operations. Such data may include, for instance, information regarding subterranean formations, equipment, and historical and/or other data.

An oilfield application may include software that supports the operation and/or planning of oilfield operations. An exemplary oilfield application may include a simulator designed to model specific behavior of discrete portions of the wellbore operation using the collected data. Due to the complexity of the oilfield operation, the oilfield application may be designed using a closed software architecture accessible to only certain oilfield application developers. As a result, creating new functionalities in the oilfield application is limited to a small group of oilfield application developers. Adding new functionalities to the oilfield application traditionally requires the entire oilfield application to be updated. For example, in order to alter or enhance various functionalities of the oilfield application, developers who have access to the closed software architecture of the oilfield application would create a new version of the existing oilfield application such that the new functionalities are included in the new version of the oilfield application.

### SUMMARY

Described herein are implementations of various technologies for an oilfield application system. In one implementation, the oilfield application system may be a computerized system that includes an oilfield application configured to perform geological interpretation functions such as identifying one or more hydrocarbon deposits in the earth. The computerized system may also include an oilfield application development kit that provides a software architecture for developing one or more plug-in components that may be executable by the oilfield application. The computerized system may also include an online distribution center that facilitates access to the plug-in components.

Described herein are implementations of various techniques for using the oilfield application system. In one implementation, the oilfield application system may be used to make one or more plug-in components available for download. The method may include receiving the plug-in components configured to run with the oilfield application. After receiving the plug-in components, the method may perform one or more quality checks on the plug-in components. The method may then include determining whether the quality checks meet a predefined standard. If the quality checks meet the predefined standard, then the method may create one or more online representations for the plug-in components. After creating the online representations, the method may include publishing the online representations on an Internet site.

In another implementation, the oilfield application system may be used to recommend one or more plug-in components for an oilfield application of interest to a user. The method for recommending the plug-in components may include determining the plug-in components of interest to the user based on one or more plug-in components installed on the oilfield application, one or more activities performed by the user on an online distribution center having the plug-in components stored therein, account information of the user stored on the online distribution center, or combinations thereof. After determining the plug-in components of interest to the user, the method may include displaying the plug-in components of interest to the user.

In yet another implementation, the oilfield application system may be used to identify a plug-in component that is causing a problem on an oilfield application. The method for identifying a plug-in component that is causing a problem on an oilfield application may include receiving an exception message indicating that an error has occurred in a programming code of the plug-in component that is executable by the oilfield application. The method may then include mapping the exception message to the plug-in component using a map of dependencies that indicates how one or more software components are related to each other. After mapping the exception message, the method may display an option to disable the plug-in component. Upon receiving a command to disable the plug-in component, the method may include disabling the plug-in component.

In yet another implementation, the oilfield application system may be used to update a plug-in component installed on an oilfield application. The method may include identifying one or more plug-in components installed on the oilfield application such that the plug-in components use one or more dependent plug-in components to perform their functions. After identifying the installed plug-in components, the method may include identifying the dependent plug-in components and determining whether one or more updates for the plug-in components or the dependent plug-in components are available for download on an online distribution center. The online distribution center may store the updates for the plug-in components or the dependent plug-in components. The method may then include downloading the updates from the online distribution center and installing the updates on the oilfield application.

In yet another implementation, the oilfield application system may be used to transfer one or more plug-in components from a first version of an oilfield application to a second version of the oilfield application. The method may include identifying one or more plug-in components installed on the first version of the oilfield application and identifying one or more plug-in components that are dependent on the first identified plug-in components. The dependent plug-in components may be used to perform the functions of the first identified plug-in components. After identifying the dependent plug-in components, the method may include determining whether the plug-in components and the dependent plug-in components are compatible with the second version of the oilfield application. If it is determined that the plug-in components and the dependent plug-in components are compatible with the second version of the oilfield application, the method may include downloading the plug-in components and the dependent plug-in components from an online distribution center having the plug-in components and the dependent plug-in components stored therein. After downloading the plug-in components and the dependent plug-in components, the method may include installing the plug-in components and the dependent plug-in components on the second version of the oilfield application.

The claimed subject matter is not limited to implementations that solve any or all of the noted disadvantages. Further, the summary section is provided to introduce a selection of concepts in a simplified form that are further described below in the detailed description section. The summary section is not intended to identify key or essential features of the claimed subject matter, nor is it intended to be used to limit the scope of the claimed subject matter.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIGS. 1.1-1.4 illustrate simplified, schematic views of an oilfield having subterranean formations containing reservoirs therein in accordance with implementations of various technologies and techniques described herein.

FIG. 2 illustrates a schematic view, partially in cross section of an oilfield having a plurality of data acquisition tools positioned at various locations along the oilfield for collecting data from the subterranean formations in accordance with implementations of various technologies and techniques described herein.

FIG. 3 illustrates a production system for performing one or more oilfield operations in accordance with implementations of various technologies and techniques described herein.

FIG. 4 illustrates an oilfield application system in accordance with implementations of various technologies and techniques described herein.

FIG. 5 illustrates a flow diagram of a method for making plug-in components available for download in accordance with implementations of various technologies and techniques described herein.

FIG. 6 illustrates a flow diagram of a method for distributing plug-in components in accordance with implementations of various technologies and techniques described herein.

FIG. 7 illustrates a flow diagram of a method for recommending plug-in components in accordance with implementations of various technologies and techniques described herein.

FIG. 8 illustrates a flow diagram of a method for identifying problem plug-in components in accordance with implementations of various technologies and techniques described herein.

FIG. 9 illustrates a flow diagram of a method for transferring plug-in components in accordance with implementations of various technologies and techniques described herein.

FIG. 10 illustrates a computer system into which implementations of various technologies and techniques described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

### Executive Summary

The following provides a brief description of various technologies for an oilfield application system and various techniques for using the oilfield application system.

### Executive Summary—Oilfield Application System

In one implementation, the oilfield application system includes a computer system that consists of an oilfield application, a software development kit, one or more plug-in components and an Internet distribution site. In an exemplary embodiment the oilfield application may be a seismic-to-simulation platform that performs various earth modeling functions to identify areas within the earth that may contain hydrocarbon deposits. The software development kit is configured to provide a software architecture or environment for plug-in component developers to build plug-in components for the oilfield application. The software development kit may include a set of development tools to create the plug-in components that are executable on the oilfield application. The software development kit may also include an application programming interface (API) that enables the plug-in components to interact with the oilfield application. After developing plug-in components using the software development kit, plug-in component developers may direct the software development kit to package the plug-in component into a file that includes the plug-in component, information related to the identity of the plug-in component, a serialized format of the information related to the identity of the plug-in component, a list of software components that are dependent on the plug-in component, declarative installation information, and the like.

The plug-in components may be configured to enhance the oilfield application by providing new functionalities and analysis tools to obtain specialized results using the oilfield application. The plug-in components may be published on the Internet distribution site such that users may acquire more information about the plug-in components or download the plug-in components to their local computers. Before the plug-in components are published on the Internet distribution site, they may be tested for quality, compatibility, functionality, etc.

One technique for using the oilfield application system may relate to a method for developers to place their plug-in components on the Internet distribution site. In one implementation, a plug-in quality center may receive a plug-in component created by the developer using the software development kit and may store it in a server. In addition to receiving the plug-in component, the plug-in quality center may also receive an installer file, a user guide, a tutorial, marketing brochure, pictures and/or videos related to the plug-in component. After receiving these items, the plug-in quality center may perform various quality control checks on the plug-in component. The quality control checks may include testing the functionality of the plug-in component, testing the compatibility of the plug-in component with the oilfield application, and evaluating the user guide, tutorials, pictures and videos that were received with the plug-in component. The plug-in quality center may also provide a rating for the plug-in component based on the quality control checks. Once the plug-in component meets a predetermined minimum set of quality criteria, it may be stored in a software download center.

If the plug-in component meets the predetermined minimum set of quality criteria, the plug-in quality center may build an online representation of the plug-in component. The plug-in quality center may then publish the online representation of the plug-in component on the Internet distribution site. The plug-in component may be downloaded from the software download center after a consumer purchases a license to use the plug-in component from the Internet distribution site.

Another technique for using the oilfield application system may relate to a method for purchasing a plug-in component from the Internet distribution site. Here, the Internet distribution site may receive a request to purchase the plug-in component. After receiving the request to purchase, the Internet distribution site may receive payment information that indicates how the plug-in component will be purchased. The Internet distribution site may then verify that the payment information is valid. If the payment information is valid, the Internet distribution site may present a webpage having a link to download the plug-in component and license information for the plug-in component. The link may allow a user to download the plug-in component from the software download center.

### Executive Summary—Plug-in Manager

The oilfield application system may also include a plug-in manager embedded within the oilfield application. The plug-in manager may have a user interface that displays the plug-in components that are installed on the oilfield application. The plug-in manager may also be used to display licensing information pertaining to each plug-in component installed on the oilfield application, display update information pertaining to each plug-in component installed on the oilfield application, display one or more notifications indicating that an update for a pre-defined plug-in component is available for download, display one or more recommendations of plug-in components that may be available for download and the like.

In one implementation, the plug-in manager may also serve as an interface between the oilfield application and the Internet distribution site. As such, the plug-in manager may recommend plug-in components that are available on the Internet distribution site and allow users to purchase and download the recommended plug-in components from the Internet distribution site without exiting the oilfield application. The plug-in manager may recommend plug-in components for the user based on what plug-in components are currently installed on the user's oilfield application, based on the user's activities (e.g., previous searches, purchases) on the Internet distribution site, based on the user's account information (e.g., profile, pre-defined interests) on the Internet distribution site and the like.

The plug-in manager may also monitor each plug-in component and identify plug-in components that are causing a problem on the oilfield application. The plug-in manager may identify which plug-in component is causing the problem based on an exception message received at the time the problem occurred. Using the exception message, the plug-in manager may map the exception message to the plug-in component that created the exception message. In one implementation, after identifying a problem plug-in component, the user may have the option to report the problem to a support team through the distribution site, and disable the problem plug-in component.

The plug-in manager may also periodically check whether the plug-in components currently installed have new updates available on the Internet distribution site. Some plug-in components use other plug-in components to perform their functions. These “other” plug-in components may be known as dependent plug-in components. In one implementation, the plug-in manager may identify the dependent plug-in components for each installed plug-in component and periodically check whether the dependent plug-in components have new updates available on the Internet distribution site.

The plug-in manager may also manage the installation of plug-in components on a new version of the oilfield application. For instance, when a new version of the oilfield application is installed, the plug-in components installed on a previous version of the oilfield application may need to be reinstalled on the new version of the oilfield application. After the installation of the new version of the oilfield application, the plug-in manager may automatically install each plug-in component that was installed on the previous version of the oilfield application. In one implementation, the plug-in manager may determine which plug-in components are compatible with the new version of the oilfield application based on information available at the Internet distribution site before installing the plug-in components on the new version of the oilfield applications.

The plug-in manager may also be capable of performing a declarative installation such that the developers of the plug-in components can specify various changes that need to be made in the local machine for the installation of a plug-in component. Developers may specify tasks to be performed by the plug-in manager using declarative instructions embedded within the installation file of the plug-in component. Since the plug-in manager performs the installation of the plug-in component, the plug-in manager may perform the tasks specified in the declarative instructions of the installation file. The tasks specified in the declarative instructions may include renaming certain files, moving files to different directories, and the like.

The plug-in manager may also allow clients to push plug-in manager settings from a centralized location to each of the client's individual user's plug-in manager. For instance, clients may specify that the plug-in manager points to a particular location at the distribution site (e.g., specific network location). The particular location may include client specific plug-in components or plug-in component updates. In this manner, clients can specify which plug-in components its users may download based on each individual user's needs. For instance, a client may make only the plug-in components developed by the client itself available for download by the individual user.

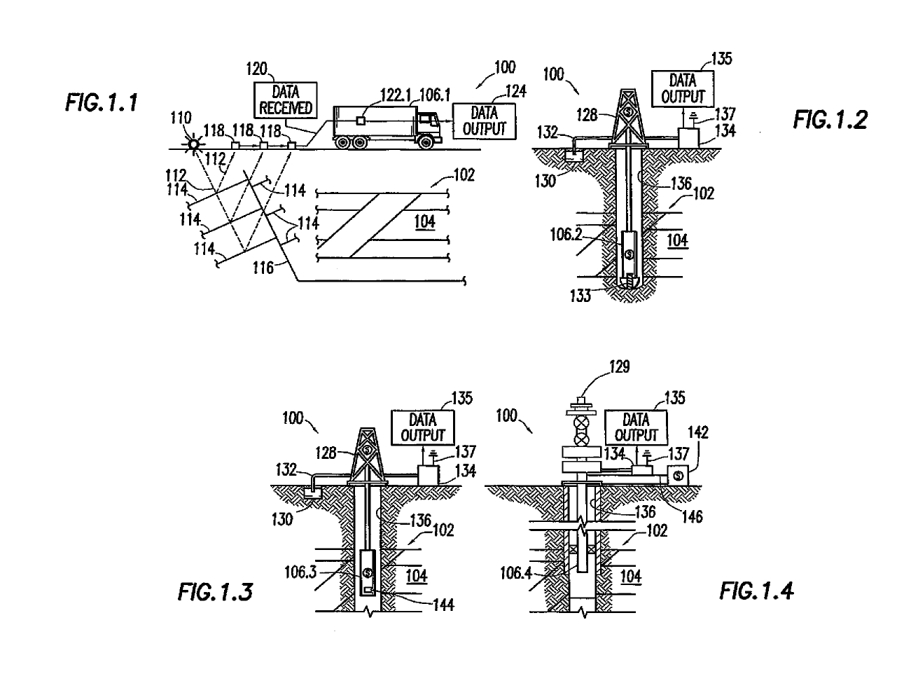

FIGS. 1-10 illustrate one or more implementations of various technologies and techniques described herein in more detail.

### Oilfield Environment

FIGS. 1.1-1.4 illustrate simplified, schematic views of oilfield 100 having subterranean formation 102 containing reservoir 104 therein in accordance with implementations of various technologies and techniques described herein. FIG. 1.1 illustrates a survey operation being performed by a survey tool, such as seismic truck 106.1, to measure properties of the subterranean formation. The survey operation is a seismic survey operation for producing sound vibrations. In FIG. 1.1, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1.2 illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is usually filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1.3 illustrates a wireline operation being performed by wireline tool 106.3 suspended by rig 128 and into wellbore 136 of FIG. 1.2. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1.1. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1.4 illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1.2-1.4 illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1.1-1.4 are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

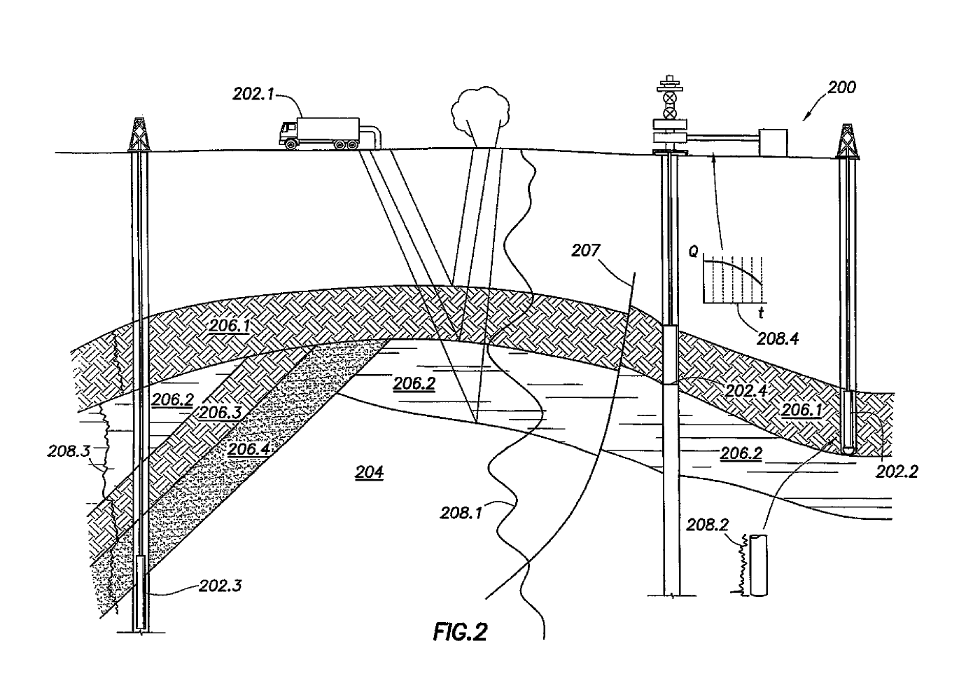

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1.1-1.4, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

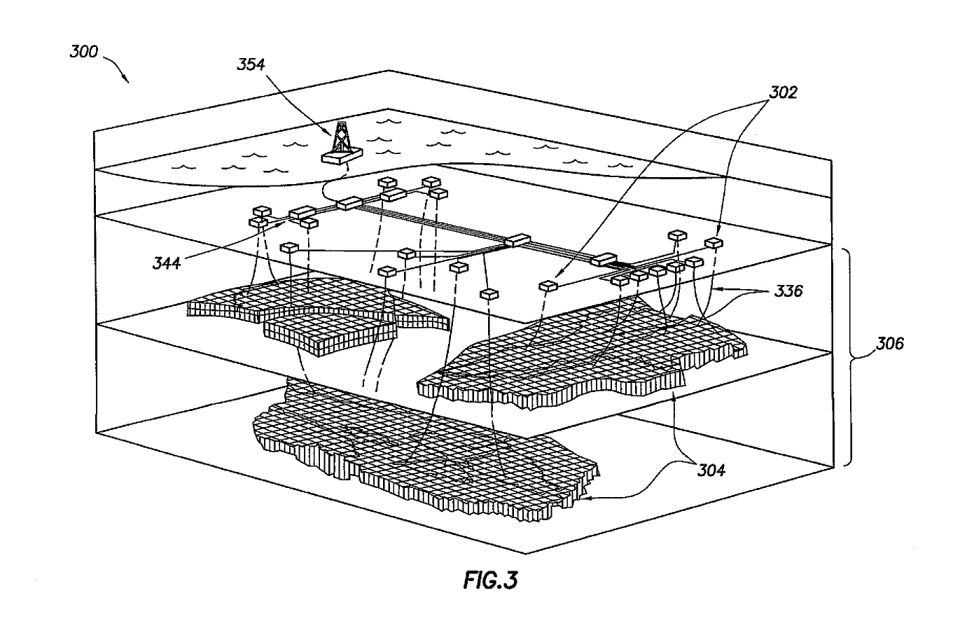

FIG. 3 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Oilfield Application System

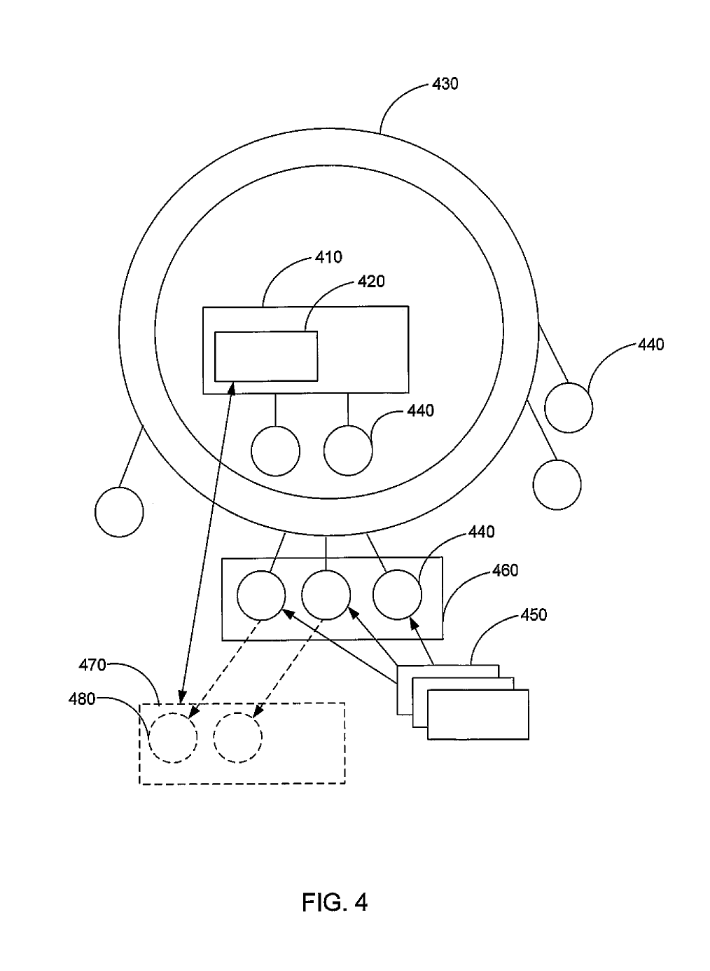

FIG. 4 illustrates an oilfield application system 400 in accordance with implementations of various technologies and techniques described herein. Oilfield application system 400 may include oilfield application 410, plug-in manager 420, oilfield application development kit 430, plug-in components 440, software developers 450, plug-in quality center 460, plug-in distribution center 470 and online plug-in component representation 480.

### Oilfield Application System—Oilfield Application

Oilfield application 410 may include a software platform and a base for software frameworks onto which functionality may be added. In one implementation, oilfield application 410 is a geological modeling/interpretation application that may be used to analyze subsurface data in order to locate subsurface areas within the Earth that have hydrocarbon deposits (e.g., reservoir). For instance, oilfield application 410 may be a seismic-to-simulation platform used to perform various earth modeling functions based on subsurface data. The subsurface data may include data acquired from data acquisition tools 106.1-106.4, surface unit 134, sensors S, as described in FIG. 1. In addition to modeling, oilfield application 410 may also be used to perform rapid 2D and 3D seismic interpretation, perform streamline simulations, create well path designs, drilling visualization, update various models in real-time and the like. Oilfield application 410 may also provide tools for systematic exploration risk analysis of charge, trap, reservoir, fault seal and the like.

### Oilfield Application System—Oilfield Application Development Kit

Oilfield application development kit 430 may be a software framework to facilitate the software development of plug-in components 440. The software framework may enable software developers 450 to devote time to meeting software requirements rather than dealing with more standard low-level coding. As such, oilfield application development kit 430 may provide a software architecture, software framework or software environment for plug-in developers (e.g., software developers 450) to build plug-in components 440 executable by oilfield application 410. Oilfield application development kit 430 may enable software developers 450 to write code for plug-in components 440 that enriches the capability of oilfield application 410. By giving software developers 450 the freedom to create specialized workflows to solve complex problems via adding plug-in components 440 using a range of tools available on oilfield application 410, the software architecture provided by oilfield application development kit 430 accelerates the development of innovative software solutions to solve particular industry challenges.

Oilfield development kit 430 may include a set of development tools for creating plug-in components 440 that are to be executed by oilfield application 410. For instance, oilfield application development kit 430 may include a basic structure for building an interface for creating oilfield plug-in components 440. The basic structure may utilize a platform for creating plug-in oilfield applications 440. This platform may provide basic building blocks for assembling oilfield plug-in components 440. As such, oilfield development kit 430 may provide software developers 450 an extensive framework to create user workflows, leveraging and extending oilfield application 410. Oilfield application development kit 430 may also include an application programming interface (API) that enables plug-in components 440 to interact with oilfield application 410. In one implementation, oilfield development kit 430 may be based on the .NET framework from Microsoft®.

Different types of oilfield development kits 430 for different types or versions of oilfield application 410 may be available for software developers 450. For instance, oilfield application 410 may be available in a full version form or a limited version form, depending on the needs of an oilfield application user. Depending on the version of oilfield application 410 software developers 450 are using, a corresponding oilfield development kit 430 may be available to create oilfield plug-in components 440 for the corresponding version of oilfield application 410. Different versions of oilfield application 410 may be available to fit the needs and costs of various oilfield application users. In this manner, oilfield development kit 430 may be customized for each individual software developer 450 such that it provides particular functionalities of oilfield application 410 (i.e., limited version) without providing all of the functionalities of oilfield application 410 (i.e., full version). Additional details pertaining to oilfield application development kit 430 may be found in U.S. Patent Application Publication 2008/0109490 and U.S. Patent Application Publication 2010/0044033, which are incorporated herein by reference.

### Oilfield Application System—Plug-in Components

Plug-in components 440, developed using oilfield application development kit 430, may enhance oilfield application 410 by providing new functionalities and analysis tools that obtain specialized results which cannot be acquired using oilfield application 410 alone. As such, plug-in component 440 may be a computer program that interacts with a host application, such as oilfield application 410, to provide new functionalities. The new functionalities created by plug-in components 440 are thus available to a user without acquiring a new version of oilfield application 410. In one implementation, plug-in components 440 may include an installer file, a number of data files, a user guide, a tutorial, a marketing brochure, pictures and/or videos related to plug-in components 440, and the like.

Plug-in components 440 may be developed by software developers 450. Software developers 450 may include oil companies, universities, software companies and the like. Software developers 450 may cater to the specialized needs of a variety of oilfield application 410 users. In this manner, oilfield application 410 users may have a wide variety of software developers 450 available to them to create plug-in components 440 that are designed to solve the specialized needs of the oilfield application 410 users. By using oilfield application developer kit 430, software developers 450 may avoid spending research and development time and money in reinventing oilfield application 410; instead, software developers 450 may concentrate on creating solutions for the analysis problems of a variety of oilfield application 410 users.

In one implementation, after creating plug-in components 440, oilfield application development kit 430 may package plug-in component 440 into a file such that the file may include plug-in component 440, information related to the identity of the plug-in component 440 (i.e., plug-in identifier), declarative installation information, dependent plug-in components related to the plug-in component 440 and the like.

Plug-in identifier may be a serialized format of the information related to the identity of plug-in component 440. Plug-in identifier may be a durable unique plug-in identity. In one implementation, plug-in identifier may allow software developers 450 to uniquely identify their plug-in components 440 in plug-in distribution center 470 and/or in their local runtime application environment. Plug-in identifier may be stored locally as part of the data for oilfield application 410 or as part of a catalog in plug-in distribution center 470. In one implementation, the plug-in identifier may be serialized, stored and transmitted through an update service to plug-in distribution center 470. Here, plug-in identifier may be used to match plug-in component 440 to a particular catalog in plug-in distribution center 470 for update services and for obtaining plug-in recommendations.

In one implementation, plug-in identifier may be a software class defined by software developers 450. Each plug-in component 440 may be associated to a specific plug-in identifier which may include a specific identification tag for plug-in component 440, a list of modules related to plug-in component 440, and the like. For instance, plug-in identifier may define a name, a description, an image resource name, a module uniform resource identity, a unique identification such as a Globally Unique Identifier (GUID), a trust value, a release date, a plugin author, a version of oilfield application 410 compatible with plug-in component 440, legacy information, a code base location, a start mode definition, a startup action, and the like for plug-in component 440.

### Oilfield Application System—Plug-in Quality Center

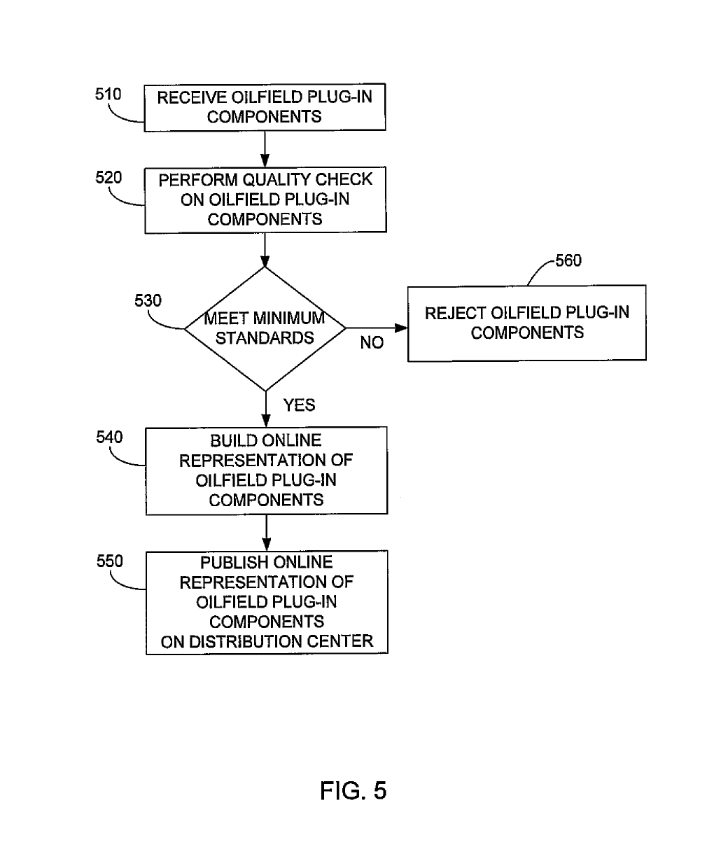

After software developers 450 create plug-in components 440, they may upload plug-in components 440 to plug-in quality center 460. Plug-in quality center 460 may be stored on a server that is available to software developers 450 via the Internet and the like. Plug-in quality center 460 may test plug-in components 440 for quality and functionality. In one implementation, plug-in quality center 460 may install plug-in components 440 on an oilfield application stored on its server to ensure that the newly uploaded plug-in components 440 operate properly with oilfield application. Various other quality tests may also be performed to ensure that plug-in components 440 do not affect the stability or functionality of oilfield application 410. A list of some quality tests performed on plug-in components 440 is provided below with reference to FIG. 5.

Plug-in quality center 460 may also determine whether the newly uploaded plug-in components 440 meet a predetermined minimum standard for publishing. If plug-in components 440 meet the minimum standards, plug-in quality center 460 may build online representations of plug-in components 440 (i.e., online plug-in component representations 480) to be published on plug-in distribution center 470.

In one implementation, online plug-in component representations 480 may include webpages that have information related to plug-in components 440 such as a brief description of plug-in components 440, a list of features of plug-in components 440, a list of specifications for plug-in components 440, a price for downloading plug-in components 440, a rating plug-in components 440 as determined by plug-in quality center 460, a rating for plug-in components 440 as determined by users, screen shots of plug-in components 440, user reviews of plug-in components 440 and the like. Online plug-in component representations 480 may also include links configured to download plug-in components 440, brochures related to plug-in components 440, user guides for plug-in components 440, screen shots for plug-in components 440, videos for plug-in components 440, and the like. In one implementation, the data/installation files related to plug-in components 440 may be stored on a server separate from plug-in distribution center 470, such as a software download center which may store various types of software in addition to plug-in components 440.

### Oilfield Application System—Plug-in Distribution Center

After building online plug-in component representations 480, plug-in quality center 460 may send online plug-in component representations 480 to plug-in distribution center 470. Plug-in distribution center 470 may be a server that is accessible by anyone via the Internet. In one implementation, plug-in distribution center 470 may organize online plug-in component representations 480 on webpages based on its functionality. For instance, online plug-in component representations 480 may be organized based on its domain such as drilling, geology, geophysics, production, geomechanics, information management, petrophysics, reservoir engineering, reservoir modeling and the like. Online plug-in component representations 480 may also be organized based on its theme such as carbonate, conventional, deep water, heavy oil, unconventional gas and the like.

Plug-in distribution center 470 may also provide a link to download plug-in components 440 to local computers. The link to download plug-in components 440 may be an Internet link to the software download center where plug-in components 440 are stored. In one implementation, plug-in distribution center 470 may include development spaces (e.g., communication channels) for software developers 450 to interact, discuss and possibly collaborate on the development of oilfield plug-in components 440.

Although plug-in distribution center 470 has been described as providing users access to download plug-in components 440, it should be noted that in other implementations, plug-in distribution center 470 may also provide users access to download various other software components that may or may not be related to oilfield application 410.

### Oilfield Application System—Plug-in Manager

Once plug-in components 440 are installed on local computers, plug-in manager 420 may manage various aspects of the installed plug-in components. Plug-in manager 420 may also serve as an interface to the plug-in distribution center 470 from oilfield application 410. Some of the characteristics and functionalities of plug-in manager 420 are provided below.

Plug-in Manager—User Interface

In one implementation, plug-in manager 420 may be used as a user interface to display all of the plug-in components 440 that are available for use with oilfield application 410. In one implementation, plug-in manager 420 may be downloaded from an Internet site such as plug-in distribution center 470. After installing plug-in manager 420, plug-in manager 420 may become embedded within oilfield application 410 such that plug-in manager 420 may be used to initiate oilfield plug-in components 440 that have already been installed on the local machine. Plug-in manager 420 may display the installed oilfield plug-in components 440, display the licensing information pertaining to each oilfield plug-in component 440 available on oilfield application 410, display update information pertaining to when each oilfield plug-in component 440 update may be available for download, display one or more notifications indicating that a pre-defined oilfield plug-in component 440 is available for download, and the like. The licensing information may include dates indicating when the licenses for plug-in components 440 will expire.

Plug-in Manager—Search Engine

Plug-in manager 420 may also allow users to search online plug-in component representations 480 currently available on plug-in distribution center 470. In this manner, plug-in manager 420 may allow users to interact with plug-in distribution center 470 while working on oilfield application 410.

Plug-in Manager—Plug-in Recommendations

Plug-in manager 420 may also recommend plug-in components 440 available on plug-in distribution center 470 that may be of interest to oilfield application 410 users based on the user's usage of oilfield application 410. Plug-in manager 420 may also manage the installation of each oilfield plug-in component 440, identify oilfield plug-in components 440 that may be causing a problem on oilfield application 410, periodically check for updated oilfield plug-in components 440 available on plug-in distribution center 470, automatically install oilfield plug-in components 440 on new versions of oilfield application 410 and the like.

Plug-in Manager—Installation Manager

When installing plug-in components 440, plug-in manager 420 may manage the installation of each plug-in component 440. In one implementation, plug-in manager 420 may be capable of performing declarative installation instructions that may be embedded within the installation files of plug-in component 440. Declarative instructions are defined by software developers 450. The declarative instructions specify the steps for plug-in manager 420 to perform to properly install plug-in component 440. For instance, declarative instructions may include making changes to certain file extensions within the local machine, copying various files to different directories, renaming certain files, and the like. Although plug-in manager 420 has been described as being used to install plug-in components 440, it should be noted that plug-in manager 420 may also be used to uninstall plug-in components 440.

Plug-in Manager—Client Configuration

In one implementation, plug-in manager 420 may include a user interface which may be configurable by a client. For instance, the client may configure the user interface to display plug-in components 440 that were developed internally by the client, display plug-in components 440 that are directed at a specific domain or theme, and the like. The client may configure the user interface by providing a plug-in address/path to plug-in manager 420 such that the user interface may only display plug-in components 440 that are in the corresponding plug-in address/path. The plug-in address/path may be a network address or a local address. In one implementation, the client may push the configuration to plug-in manager 420 from a centralized location over the Internet and the like.

Plug-in Manager—Security Settings

Plug-in manager 420 may also allow users to set a security setting for plug-in components 440 that may be recommended or downloaded by plug-in manager 420. For instance, plug-in manager 420 may have low, medium, high, and very high settings. The low setting may allow any plug-in component 440. The medium setting may allow any plug-in component 440 that has an identifiable publisher. The high setting may allow any plug-in component 440 from a trusted publisher as defined by the client. The very high setting may allow only those plug-in components 440 that are published by Schlumberger. In one implementation, the client may push the security settings to plug-in manager 420 from a centralized location defined by the client and the like.

Plug-in Manager—Memory Management

Plug-in manager 420 may also monitor the memory usage of each plug-in component 440. In one implementation, the memory usage may be related to the amount of Random Access Memory (RAM) being used while running each plug-in component 440. Plug-in manager 420 may allow a user to disable a plug-in component 440 in order to manage the memory usage of all of the plug-in components 440.

### Methodologies

### Methodologies—Uploading Plug-in Components Using the Oilfield Application System

FIG. 5 illustrates a flow diagram of a method 500 for making plug-in components available for download in accordance with implementations of various technologies and techniques described herein. In one implementation, method 500 may be performed by a plug-in quality application stored on a server (e.g., plug-in quality center 460). It should be understood that while method 500 indicates a particular order of execution of the operations, in some implementations, certain portions of the operations might be executed in a different order. The following description of method 500 is provided with reference to oilfield application system 400 of FIG. 4.

At step 510, the plug-in quality application may receive plug-in component 440 created by software developer 450 using oilfield development kit 430. The plug-in quality application may receive plug-in component 440 via the Internet or some other network connection. In addition to receiving plug-in component 440, the plug-in quality application may also receive an installer file, a number of data files, a user guide, a tutorial, marketing brochure, pictures and/or videos associated with plug-in component 440. In one implementation, the plug-in quality application may receive additional information related to plug-in component 440, such as the list of items provided below. However, it should be understood that the list below is merely a sample of some of the additional information that may be received and does not represent a complete list of the additional information that may be received.

General information
Plug-in component name
Plug-in component developer
Plug-in component technical contact
Plug-in component country of origin
Suggested retail price
Monthly cost to be displayed on plug-in distribution center
Discipline (e.g., Petrophysics, Geophysics, Geology, Simulation, Production, Drilling, Economics, Other)
Workflow (e.g., G&G, Well Planning, Modeling, Fault Analysis, Heavy Oil, Carbonates, Data Transfer, Other)
Go-live date
Trade compliance classification
Developer's profile
Whether plug-in component was developed for a specific client
Whether a plug-in install kit is available
Whether evaluation licenses be available, and if so, for what duration
Whether plug-in component has a support plan
Whether plug-in component can be delivered exclusively via download

Marketing information
Functional description
Workflow demo video
Presentations
Image files (i.e., screen shots)
URL to plug-in component website

Technical Information
Version of oilfield application development kit used to develop plug-in component
Version of oilfield application compatible with plug-in component
Whether source code is available
Who manages the source code
Whether plug-in component is dependent on other plug-in components
Installation guide
Release notes
What documentation will be available at plug-in distribution center
What documentation will be included with plug-in installation

Quality information
Test plan, test data and results
Version of oilfield application development kit tested against

In one implementation, after receiving oilfield plug-in component 440, the plug-in quality application may assist software developers 450 in securing an Export Certification from plug-in distribution center 470, assign a Title & License Feature name to oilfield plug-in component 440 after reviewing the functionality of oilfield plug-in component 440, communicate the license feature name to the software developers and receive a copy of the plug-in with new license, assign a discipline and workflow categories to oilfield plug-in component 440 after consultation with plug-in distribution center 470 and various experts, assign a price to oilfield plug-in component 440, ensure that all required contracts are in place, and use the received information to prepare a packing checklist for plug-in quality center 460. A list of items that may be included in the packing checklist is provided below. However, it should be understood that the list below is merely a sample of some of the items that may be included in the packing checklist and does not represent a complete list of the items that may be included in the packing checklist.

General
A license feature name
Whether the developer is a oilfield application or oilfield application development kit client
Whether the developer is a user of oilfield application
Whether the developer is a software developer

Contracts
Whether the developer owns oilfield application development kit
Whether contractual agreements have been signed
Whether oilfield plug-in component requires a third party agreement
whether trade compliance review has been completed

Functionality
Whether a similar functionality is already listed on plug-in distribution center
Whether oilfield plug-in component is up to date with latest oilfield application development kit
Whether oilfield plug-in component uses standard licensing
Whether oilfield plug-in component has a support plan

Pricing
Suggested retail price
Suggested price for upgrade assurance
Whether this is a special client
Whether a consultation and review with GeoMarket has been performed

At step 520, the plug-in quality application may perform various quality control checks on plug-in component 440. The quality control checks may include testing the functionality of plug-in components 440, testing the compatibility of plug-in components 440 with oilfield application 410, evaluating the user guide, tutorials, pictures and videos that were received with plug-in components 440, and the like. In one implementation, upon receipt of the plug-in component 440 and the packing checklist, the plug-in quality application may verify all of the provided information and gather any missing data. The plug-in quality application may review plug-in testing details provided by the developer, conduct a quality assurance test of plug-in component 440 and propose a quality rating for plug-in component 440. The plug-in quality application may review the test results, the rating and provide approval. The plug-in quality application may also upload plug-in component 440 and any related information on a staging server to test plug-in component 440 functionalities such as licenses generation, plug-in component 440 download, install and the like.

In one implementation, the plug-in quality application may evaluate a quality checklist when performing the various quality control checks on plug-in component 440. The quality checklist may include the following items. However, it should be understood that the list below is merely an example of some of the items that may be included in the quality checklist and does not represent a complete list of the items that may be included in the quality checklist.

Plug-in and Marketing Information
Whether audit, test plan and results for plug-in component (submitted by the developer) has been reviewed and verified
Whether plug-in component passed a security check (e.g., virus scan)
Whether plug-in component is compatible with current versions of oilfield application and oilfield software development kit

Quality Attributes
Test coverage (e.g., depth of test plan)
Licensing method (e.g., standard vs. custom)
Ability and provision for post sales support
Quality of marketing material
Quality of documentation (e.g., install guide, training material etc.)
List of known issues and workarounds
Consistency of user interface with other plug-in components, oilfield application, oilfield software development kit

Quality Rating
Bronze
Silver
Gold

In one implementation, the plug-in quality application may determine the quality rating for plug-in component 440 based on how well plug-in component 440 performed with the quality checklist.

At step 530, the plug-in quality application may determine whether plug-in component 440 meets a predetermined set of minimum standards. The predetermined set of minimum standards may include testing that plug-in component 440 is compatible with oilfield application 410 and functions properly. A list of other minimum standards is provided below. However, it should be understood that the list below is merely a sample of some of the items that may be included in the minimum standards and does not represent a complete list of the items that may be included in the minimum standards.

Plug-in Quality Assurance and Preparation
Whether Packing Checklist was content reviewed & verified
Whether oilfield software development kit compliance audit was performed
Whether sanity test on current version of oilfield software development kit was performed

Staging Quality Assurance and Preparation
Whether developer was authenticated and added to the system
Whether plug-in component was added to the system
Whether licenses for plug-in component was created and tested
Whether plug-in component has been reviewed, downloaded and tested
Whether marketing material has been reviewed and tested
Whether source code has been catalogued

Customer Care Center
Whether plug-in component has been added to the system
Whether developer name and support information for plug-in component has been added to the system

If the plug-in quality application determines that oilfield plug-in component 440 meets the predetermined set of minimum standards, the plug-in quality application may proceed to step 540. At step 540, the plug-in quality application may build an online representation of plug-in component 440 (i.e., online plug-in component representation 480). Online plug-in component representation 480 may include web pages, icons and the like. Online plug-in component representation 480 may be published on an Internet site, such as plug-in distribution center 470 and made available for view and download. In one implementation, online plug-in component representation 480 may include information related to plug-in components 440, such as a brief description of plug-in components 440, a list of features of plug-in components 440, a list of specifications for plug-in components 440, a price for downloading plug-in components 440, a rating for plug-in components 440 as determined by plug-in quality center 460 and a rating for plug-in components 440 as determined by users, screen shots of plug-in components 440, user reviews of plug-in components 440 and the like.

At step 550, the plug-in quality application may publish online plug-in component representation 480 on plug-in distribution center 470. In one implementation, the plug-in quality application may determine a domain or theme for online plug-in component representation 480 before publishing online plug-in component representation 480. As such, online plug-in component representation 480 may be organized according to its domains (e.g., drilling, geology, geophysics, production, geomechanics, information management, petrophysics, reservoir engineering, reservoir modeling and the like). Online oilfield plug-in component representation 480 may also be organized according to its themes (e.g., carbonate, conventional, deep water, heavy oil, unconventional gas and the like). The plug-in quality application may then publish the online plug-in component representation 480 based on the domains and the themes.

Referring back to step 530, if the plug-in quality application determines that plug-in components 440 do not meet the predetermined set of minimum standards, the plug-in quality application may proceed to step 560. At step 560, the plug-in quality application may reject plug-in component 440. In one implementation, the plug-in quality application may send a message to the software developer 450 that created the corresponding plug-in component 440 indicating that his plug-in component 440 failed to meet the minimum standards required for publication. The message may provide details describing why the plug-in component 440 failed to meet the minimum standards and recommendations for meeting the minimum standards.

### Methodologies—Downloading Plug-in Components Using the Oilfield Application System

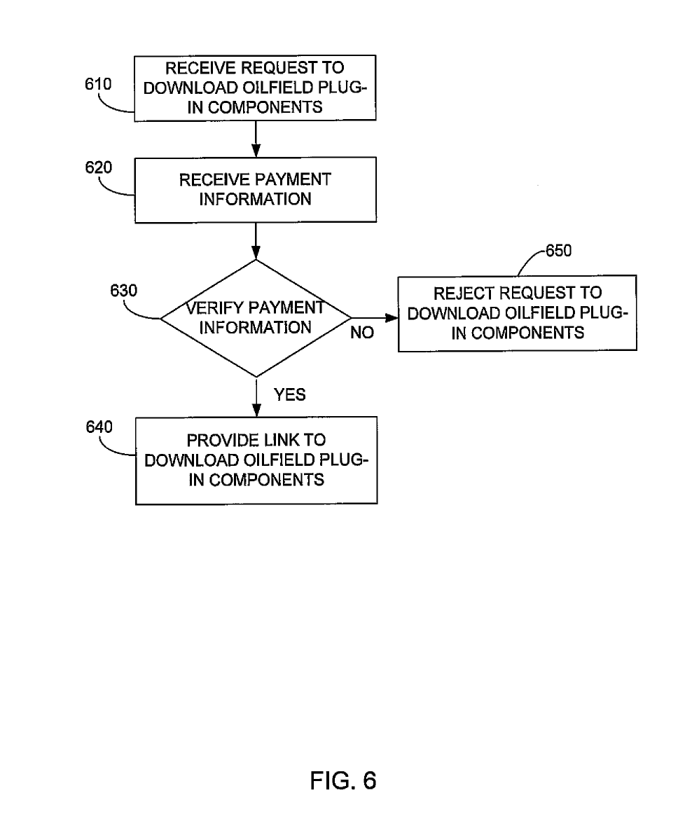

FIG. 6 illustrates a flow diagram of a method 600 for distributing plug-in component in accordance with implementations of various technologies and techniques described herein. In one implementation, method 600 may be performed by a plug-in distribution application stored on a server (e.g., plug-in distribution center 470). It should be understood that while method 600 indicates a particular order of execution of the operations, in some implementations, certain portions of the operations might be executed in a different order. The following description of method 600 is provided with reference to oilfield application system 400 of FIG. 4.

At step 610, the plug-in distribution application may receive a request to download plug-in component 440. In one implementation, the request may be received when a user accesses online plug-in component representation 480 that corresponds to the plug-in component 440.

At step 620, the plug-in distribution application may receive payment information such as a purchase order number, a client account number, a credit card number, a bank account number or the like.

At step 630, the plug-in distribution application may verify that the payment information is valid. The validity of a payment may be based on whether a sufficient amount of funds are available purchase plug-in component 440.

If the payment information is verified, the plug-in distribution application may proceed to step 640. At step 640, the plug-in distribution application may provide a link to download plug-in component 440. The link may allow a user to download plug-in component 440 which may be stored in a software download center separate from plug-in distribution center 470. The plug-in distribution application may also display a license and an expiration date for the license that corresponds to the downloaded plug-in component 440.

In one implementation, the plug-in distribution application may store information related to the sale of each plug-in component 440 for each customer. The plug-in distribution application may then recommend other plug-in components 440 that may be related to the plug-in component 440 that the customer previously downloaded.

Referring back to step 630, if the payment information is not verified, the plug-in distribution application may proceed to step 650. At step 650, the plug-in distribution application may reject the request to download plug-in component 440. In one implementation, the plug-in distribution application may send a message to the user who requested to download plug-in component 440 indicating that the payment information could not be verified. The message may provide details describing why the oilfield plug-in component 440 could not be verified and may include recommendations for correcting the payment information.

### Methodologies—Recommending Plug-in Components Using the Plug-in Manager

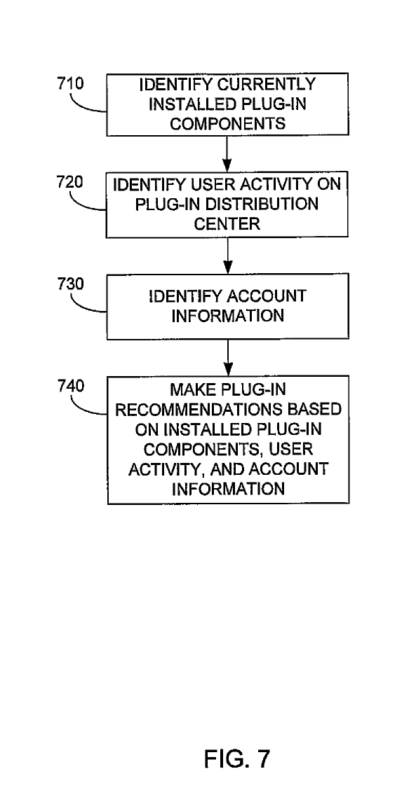

FIG. 7 illustrates a flow diagram of a method 700 for recommending plug-in components in accordance with implementations of various technologies and techniques described herein. In one implementation, method 700 may be performed by plug-in manager 420. It should be understood that while method 700 indicates a particular order of execution of the operations, in some implementations, certain portions of the operations might be executed in a different order. The following description of method 700 is provided with reference to oilfield application system 400 of FIG. 4.

At step 710, plug-in manager 420 may determine which plug-in components 440 are currently installed on oilfield application 410. At step 720, plug-in manager 420 may access distribution center 470 to identify the activities performed by the user of oilfield application 410. The activities may include searches performed on plug-in distribution center 470 and purchases made on plug-in distribution center 470. At step 730, plug-in manager 420 may access distribution center 470 to identify the account information of the user on plug-in distribution center 470. The account information may include profile information for the user that includes pre-defined interests, pre-defined plug-in components 440, an industry in which the user uses plug-in components 440, and the like.

At step 740, plug-in manager 420 may make one or more recommendations based on the information received at steps 710-730. In one implementation, plug-in manager 420 may make recommendations based on the plug-in components 440 that are currently installed on oilfield application 410. Here, plug-in manager 420 may determine which domain or theme corresponds to the installed plug-in components 440. Plug-in manager 420 may then recommend a plug-in component 440 available on plug-in distribution center 470 that is within the same domain or theme as the installed plug-in components 440 but has not been installed on oilfield application 410.

In another implementation, plug-in manager 420 may make recommendations based on the activities performed by the user of oilfield application 410 on plug-in distribution center 470. For instance, plug-in manager 420 may determine which domain or theme corresponds to the activities performed by the user. Plug-in manager 420 may then recommend a plug-in component 440 available on plug-in distribution center 470 that is within the same domain or theme as activities performed by the user but has not been installed on oilfield application 410.

In yet another implementation, plug-in manager 420 may make recommendations based on the account information of the user of oilfield application 410 according to plug-in distribution center 470. For instance, plug-in manager 420 may determine which domain or theme corresponds to the account information of the user. Plug-in manager 420 may then recommend a plug-in component 440 available on plug-in distribution center 470 that is within the domain that corresponds to the account information.

In yet another implementation, plug-in manager 420 may make recommendations based the plug-in components 440 that are currently installed on oilfield application 410, the activities performed by the user of oilfield application 410 on plug-in distribution center 470 and the account information of the user of oilfield application 410 according to plug-in distribution center 470.

### Methodologies—Identifying Problem Plug-in Components Using the Plug-in Manager

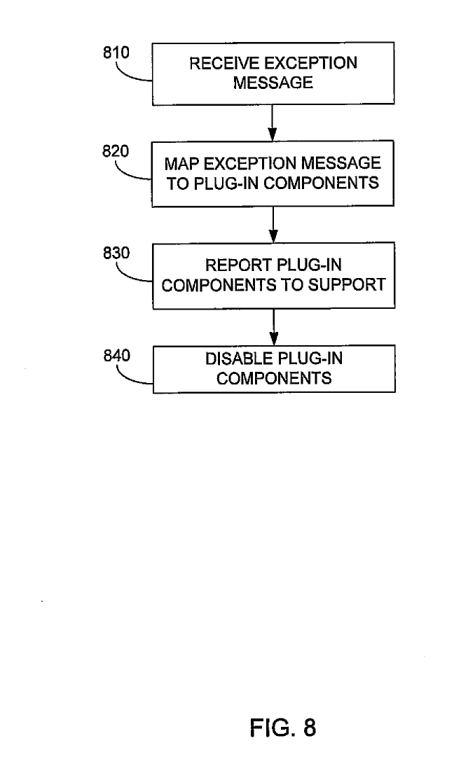

FIG. 8 illustrates a flow diagram of a method for identifying problem plug-in components in accordance with implementations of various technologies and techniques described herein. In one implementation, method 800 may be performed by plug-in manager 420. It should be understood that while method 800 indicates a particular order of execution of the operations, in some implementations, certain portions of the operations might be executed in a different order. The following description of method 800 is provided with reference to oilfield application system 400 of FIG. 4.

At step 810, plug-in manager 420 may receive an exception message from a plug-in component 440. The exception message may be created when an error occurs in the programming code of a corresponding plug-in component 440. In one implementation, when each plug-in component 440 is installed, plug-in manager 420 may analyze the installation of plug-in manager 420 to determine what software components are used by plug-in component 440. Software components may include a software package or module that performs a set of functions used to perform the function of the installed plug-in component 440. For instance, the installed plug-in component 440 may be an seismic inversion tool used to convert seismic data to acoustic impedance and allow geoscientist to quickly determine the parameters for generating an optimum operator. The inversion tool may use a graphing component to create an image of the subterranean region of the earth after an inversion algorithm is performed by the tool. The graphing component may be a software component that is installed with the corresponding plug-in component 440. Software components may also include other plug-in components 440 that may be invoked or used by the installed plug-in component 440. These software components may be known as “dependencies” because the functionality of the installed plug-in component 440 may be dependent on these software components. When plug-in manager 420 installs plug-in component 440, plug-in manager 420 may create a mapping between the software components and their corresponding installed plug-in component 440. In one implementation, the mapping between the software components and their corresponding installed plug-in component 440 may be listed in a catalog on plug-in distribution center 470.

Referring back to step 810, the exception message may be associated with a particular software component. At step 820, plug-in manager 420 may map the software component associated with the exception message to the corresponding plug-in component 440 based on the mapping described above.

At step 830, plug-in manager 420 may report the exception message and the corresponding plug-in component 440 to a support group on plug-in distribution center 470. At step 840, plug-in manager 420 may disable plug-in component 440 to prevent plug-in component 440 from interfering with the operation of oilfield application 410. In one implementation, plug-in manager 420 may prompt a user about whether to report the exception message and/or whether to disable plug-in component 440.

In addition to recommending plug-in components 440 and identifying problem plug-in components 440, plug-in manager 420 may periodically check plug-in distribution center 470 to determine whether an updated version of the installed plug-in components 440 are available for download. In one implementation, plug-in manager 420 may analyze each installed plug-in component 440 and its dependent software components and determine whether the installed plug-in component 440 or the dependent software components (e.g., dependent plug-in components) have updated versions available on plug-in distribution center 470. After identifying updated versions of plug-in components 440 on plug-in distribution center 470, plug-in manager 420 may determine whether the updated versions of plug-in components 440 will work with the dependent plug-in components 440 and/or the installed version of oilfield application 410. In one implementation, plug-in distribution center 470 may indicate which version of dependent plug-in components 440 and which version of oilfield application 410 may operate with each plug-in component 440 available on plug-in distribution center 470. In one implementation, this information may be indicated on online plug-in component representations 480.

### Methodologies—Transferring Plug-in Components Using the Plug-in Manager

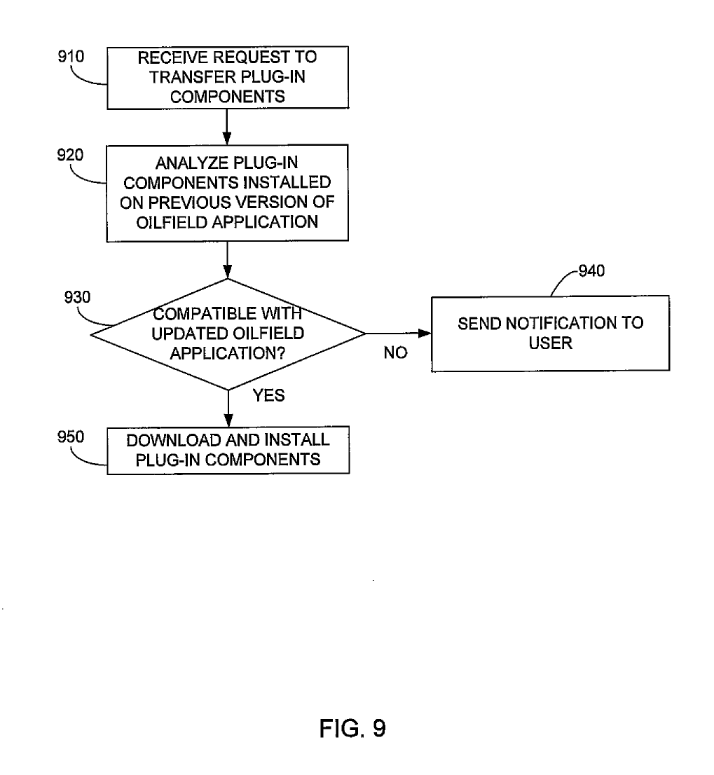

FIG. 9 illustrates a flow diagram of a method for transferring plug-in components in accordance with implementations of various technologies and techniques described herein. In one implementation, method 900 may be performed by plug-in manager 420. It should be understood that while method 900 indicates a particular order of execution of the operations, in some implementations, certain portions of the operations might be executed in a different order. The following description of method 900 is provided with reference to oilfield application system 400 of FIG. 4.

Method 900 describes a process in which plug-in manager 420 may transfer plug-in components 440 installed on a previous version of oilfield application 410 to a new version of oilfield application 410. In order to transfer the plug-in components, plug-in manager 420 may need to install each plug-in component 440 onto the new version of oilfield application 410.

At step 910, plug-in manager 420 may receive a request from a user to install plug-in components 440 from a previous version of oilfield application 410 to a new version of oilfield application 410.

At step 920, plug-in manager 420 may analyze the previous version of oilfield application 410 to determine which plug-in components 440 are installed therein. After determining the plug-in components 440 that are installed on the previous version of oilfield application 410, plug-in manager 420 may determine the dependent plug-in components 440 for each installed plug-in component 440 using a mapping created during the installation of the installed plug-in components 440.

At step 930, plug-in manager 420 may determine whether each installed plug-in component 440 and dependent plug-in components 440 are compatible with the new version of oilfield application 410. In order to determine whether plug-in components 440 are compatible with the new version of oilfield application 410, plug-in manager 420 may connect to plug-in distribution center 470 and check the information presented on the corresponding online plug-in component representation 480. If plug-in manager 420 determines that a plug-in component 440 may not be compatible with the new version of oilfield application 410, plug-in manager 420 may not install that plug-in component 440. (Step 940). In one implementation, plug-in manager 420 may send a notification to the user that the particular plug-in component 440 could not be installed due to compatibility issues.

If plug-in manager 420 determines that the installed plug-in component 440 is compatible with the new version of oilfield application, plug-in manager 420 may proceed to step 950. At step 950, plug-in manager 420 may download the installed plug-in component 440 from plug-in distribution center 470 and install the downloaded plug-in component 440 onto the new version of oilfield application 410.

After receiving the request at step 910, steps 920-950 may be performed seamlessly in the background of oilfield application 410 until all of the compatible plug-in components 440 have been installed onto the updated version of oilfield application 410.

### Computer System for Oilfield Application System

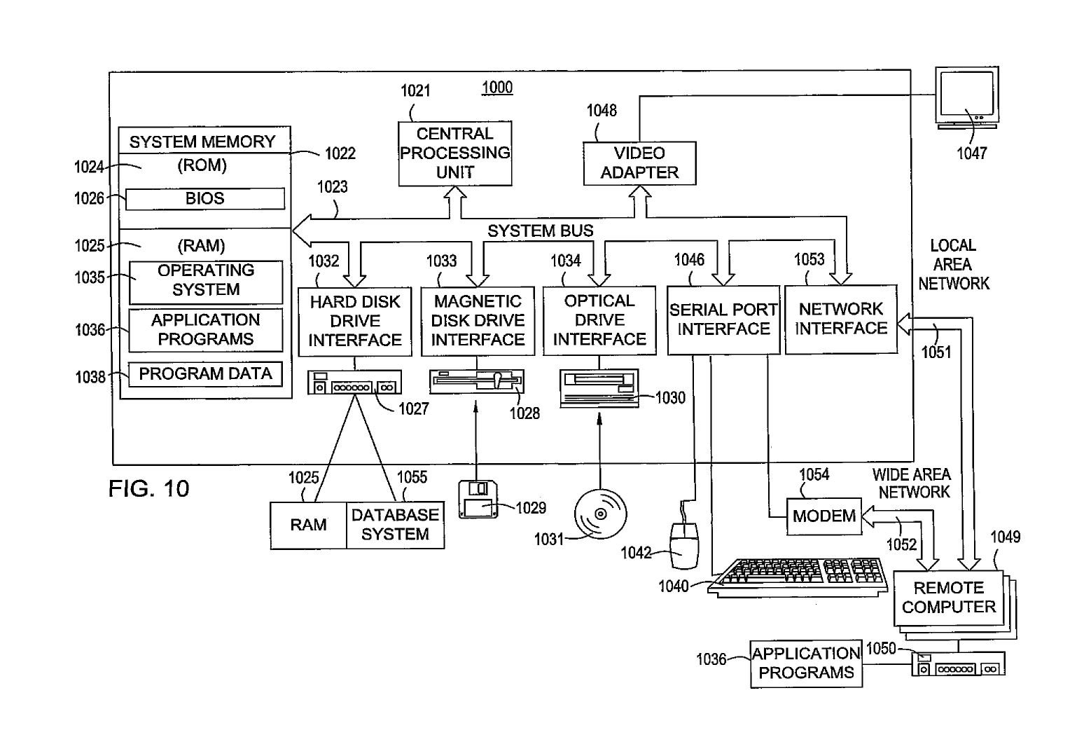

FIG. 10 illustrates a computer system 1000 into which implementations of various technologies and techniques described herein may be implemented. In one implementation, computing system 1000 may be a conventional desktop or a server computer, but it should be noted that other computer system configurations may be used.

The computing system 1000 may include a central processing unit (CPU) 1021, a system memory 1022 and a system bus 1023 that couples various system components including the system memory 1022 to the CPU 1021. Although only one CPU is illustrated in FIG. 10, it should be understood that in some implementations the computing system 1000 may include more than one CPU. The system bus 1023 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 1022 may include a read only memory (ROM) 1024 and a random access memory (RAM) 1025. A basic input/output system (BIOS) 1026, containing the basic routines that help transfer information between elements within the computing system 1000, such as during start-up, may be stored in the ROM 1024.

The computing system 1000 may further include a hard disk drive 1027 for reading from and writing to a hard disk, a magnetic disk drive 1028 for reading from and writing to a removable magnetic disk 1029, and an optical disk drive 1030 for reading from and writing to a removable optical disk 1031, such as a CD ROM or other optical media. The hard disk drive 1027, the magnetic disk drive 1028, and the optical disk drive 1030 may be connected to the system bus 1023 by a hard disk drive interface 1032, a magnetic disk drive interface 1033, and an optical drive interface 1034, respectively. The drives and their associated computer-readable media may provide nonvolatile storage of computer-readable instructions, data structures, program modules and other data for the computing system 1000.

Although the computing system 1000 is described herein as having a hard disk, a removable magnetic disk 1029 and a removable optical disk 1031, it should be appreciated by those skilled in the art that the computing system 1000 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 1000. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 1027, magnetic disk 1029, optical disk 1031, ROM 1024 or RAM 1025, including an operating system 1035, one or more application programs 1036, program data 1038, and a database system 1055. The operating system 1035 may be any suitable operating system that may control the operation of a networked personal or server computer, such as Windows® XP, Mac OS® X, Unix-variants (e.g., Linux® and BSD®), and the like. In one implementation, plug-in manager 420, oilfield application 410, the plug-in quality application and the plug-in distribution application described in FIGS. 4-9 in the paragraphs above may be stored as application programs 1036 in FIG. 10.

A user may enter commands and information into the computing system 1000 through input devices such as a keyboard 1040 and pointing device 1042. Other input devices may include a microphone, joystick, game pad, satellite dish, scanner, or the like. These and other input devices may be connected to the CPU 1021 through a serial port interface 1046 coupled to system bus 1023, but may be connected by other interfaces, such as a parallel port, game port or a universal serial bus (USB). A monitor 1047 or other type of display device may also be connected to system bus 1023 via an interface, such as a video adapter 1048. In addition to the monitor 1047, the computing system 1000 may further include other peripheral output devices such as speakers and printers.

Further, the computing system 1000 may operate in a networked environment using logical connections to one or more remote computers 1049. The logical connections may be any connection that is commonplace in offices, enterprise-wide computer networks, intranets, and the Internet, such as local area network (LAN) 1051 and a wide area network (WAN) 1052. The remote computers 1049 may each include application programs 1036 similar to that as described above. In one implementation, the plug-in quality application (i.e., performing method 500) stored in plug-in quality center 460 may be stored as application programs 1036 in system memory 1022. Similarly, the plug-in distribution application (i.e., performing method 600) stored in plug-in distribution center 470 may be stored as application programs 1036 in remote computers 1049.

When using a LAN networking environment, the computing system 1000 may be connected to the local network 1051 through a network interface or adapter 1053. When used in a WAN networking environment, the computing system 1000 may include a modem 1054, wireless router or other means for establishing communication over a wide area network 1052, such as the Internet. The modem 1054, which may be internal or external, may be connected to the system bus 1023 via the serial port interface 1046. In a networked environment, program modules depicted relative to the computing system 1000, or portions thereof, may be stored in a remote memory storage device 1050. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-49. (canceled)

50. A method for recommending a plug-in component for an oilfield application to a user, the method comprising:
developing a plug-in component executable by an oilfield application, wherein the oilfield application creates a geological model using subsurface data, and wherein the plug-in component obtains results related to the geological model that cannot be obtained by the oilfield application alone; and
recommending the plug-in component based on one or more plug-in components already installed on the oilfield application, one or more activities performed by a user of the oilfield application, account information of the user of the oilfield application, or a combination thereof.

51. The method of claim 50, further comprising recommending the plug-in component based on the one or more plug-in components already installed on the oilfield application.

52. The method of claim 51, wherein the recommended plug-in component is in the same oilfield domain as the one or more plug-in components already installed on the oilfield application.

53. The method of claim 50, further comprising recommending the plug-in component based on the one or more activities performed the user of the oilfield application.

54. The method of claim 53, wherein the one or more activities comprise one or more searches performed on an online distribution center, one or more purchases made on the online distribution center, or both.

55. The method of claim 50, further comprising recommending the plug-in component based on the account information of the user of the oilfield application.

56. The method of claim 55, wherein the account information comprises pre-defined interests of the user, a pre-defined oilfield domain identified by the user, or a combination thereof.

57. A method for updating a plug-in component installed on an oilfield application, the method comprising:
identifying a plug-in component installed on the oilfield application;
identifying a dependent plug-in component installed on the oilfield application that performs one or more functions of the plug-in component;
determining whether an update for the plug-in component or the dependent plug-in component is available for download from an online distribution center;
downloading the update; and
installing the update on the oilfield application.

58. The method of claim 57, further comprising determining whether the update for the plug-in component is available.

59. The method of claim 58, further comprising determining whether the update for the plug-in component is compatible with the dependent plug-in component installed on the oilfield application.

60. The method of claim 58, further comprising receiving an indication from the online distribution center identifying a version of the dependent plug-in component that is compatible with the update for the plug-in component.

61. The method of claim 58, further comprising receiving an indication from the online distribution center identifying a version of the oilfield application that is compatible with the update for the plug-in component.

62. The method of claim 57, further comprising determining whether the update for the dependent plug-in component is available.

63. The method of claim 62, further comprising determining whether the update for the dependent plug-in component is compatible with the plug-in component installed on the oilfield application.

64. A method for transferring a plug-in component from a first version of an oilfield application to a second version of the oilfield application, comprising:
identifying a plug-in component installed on a first version of the oilfield application;
identifying a dependent plug-in component installed on the first version of the oilfield application, wherein the plug-in component uses the dependent plug-in component to perform one or more functions;
determining whether the plug-in component and the dependent plug-in component are compatible with a second version of the oilfield application;
downloading the plug-in component and the dependent plug-in component from an online distribution center in response to determining that the plug-in component and the dependent plug-in component are compatible with the second version of the oilfield application; and
installing the plug-in component and the dependent plug-in component on the second version of the oilfield application.

65. The method of claim 64, wherein the dependent plug-in component is identified using a mapping between the plug-in component and the dependent plug-in component, and wherein the mapping is created when the plug-in component is installed on the first version of the oilfield application.

66. The method of claim 64, wherein determining whether the plug-in component and the dependent plug-in component are compatible with the second version of the oilfield application comprises locating compatibility information of the plug-in component and the dependent plug-in component on the online distribution center.

67. The method of claim 66, further comprising determining whether the plug-in component and the dependent plug-in component are compatible with the second version of the oilfield application based on the compatibility information.

68. The method of claim 64, further comprising displaying a first notification indicating that the plug-in component is unable to be installed due to compatibility issues when the plug-in component is not compatible with the second version of the oilfield application.

69. The method of claim 68, further comprising displaying a second notification indicating that the dependent plug-in component is unable to be installed due to compatibility issues when the dependent plug-in component is not compatible with the second version of the oilfield application.
